(19) United States
(12) Patent Application Publication
(10) Pub. No.: US 2005/0274899 A1
(43) Pub. Date: Dec. 15, 2005

(54) Spectroscopic system and method for analysis in harsh, changing environments

(76) Inventors: James Butler, Livonia, MI (US); Alex Colvin, Oak Park, MI (US); Thomas Korniski, Livonia, MI (US)

Correspondence Address: KILLWORTH, GOTTMAN, HAGAN & SCHAEFF, L.L.P., ONE DAYTON CENTRE, ONE SOUTH MAIN STREET, SUITE 500, DAYTON, OH, 45402-2023, US

(21) Appl. No.: 10/865,393

(22) Filed: Jun. 10, 2004

(51) Int. Cl. G01N 21/33

(52) U.S. Cl. 250/373

(57) ABSTRACT

An ultraviolet spectroscopic system and method is described that allows accurate, real-time, analysis of an ultraviolet absorbing gas species (e.g., nitric oxide) in vehicle exhaust independent of the air/fuel ratio (i.e., changing hydrocarbon concentrations). The method, which accurately accounts for the continuously changing background, allows the gas species to be measured selectively and accurately in undiluted vehicle exhaust with portable hardware that can be used on-board a vehicle.

### FIELD OF THE INVENTION

The present invention relates generally to spectroscopic measurements, and more particularly to measuring a spectral feature in an environment, that has a dramatic and quickly changing background environment.

### BACKGROUND OF THE INVENTION

Accurate spectroscopic measurements of a spectral feature in an environment that has a dramatic and quickly changing background are not possible with existing techniques. An example of this type of problem would be the ultraviolet measurement of nitric oxide (NO) in vehicle exhaust where other exhaust components (e.g., hydrocarbons) dominate the spectral region where NO must be measured.

Laboratory measurements of NO are routinely performed in dynamometer facilities and are classically based on the chemiluminescence detection of NO. Since chemiluminescence instrumentation is sensitive to vibration and requires the use of ozone, it is not suitable for on-board measurements. Other existing techniques for NO detection are complicated, insensitive, slow, or are in some way not suitable for on-board measurements.

Nitric oxide has a strong absorption spectrum in the ultraviolet region of the electromagnetic spectrum. However, using the UV region to accurately measuring NO in undiluted exhaust has not been possible due to the presence of other exhaust species that also absorb UV light. Additionally, many of these species are continuously changing in composition and in concentration, thereby affecting the background light intensities and making normal spectroscopic techniques unusable.

Accordingly, there is a need for a unique UV spectroscopic method, which accurately accounts for the continuously changing background light intensities, allowing NO to be selectively and accurately measured in undiluted vehicle exhaust with portable hardware that can be used on-board a vehicle. Instrumentation using such a method would provide valuable insight for the continuous improvement of vehicle emissions, especially in view of nitric oxide playing an important role in urban air quality, and receiving much attention by regulatory agencies and the automotive industry.

### SUMMARY OF THE INVENTION

The present invention addresses the above need by providing in one embodiment, an ultraviolet (UV) spectroscopic method that allows accurate, real-time, analysis of nitric oxide (NO) in vehicle exhaust independent of the air/fuel ratio (i.e., changing hydrocarbon concentrations effecting background light intensities). The method, which accurately accounts for the continuously changing background light intensities, allows nitric oxide to be measured selectively and accurately in undiluted vehicle exhaust with portable hardware that can be used on-board a vehicle. It is to be appreciated that ultraviolet spectrometers have recently become relatively small and portable making them attractive for use on-board a vehicle.

The present invention also includes an additional module which improves the algorithm for calculating a virtual baseline when segmented baseline offsets occur in the sample spectrum. The segmented baseline absorptions are the result of compounds present in the sample mixture that preferentially absorb radiation from only a portion of the wavelength region of interest.

In order to analyze the digital channel transmission spectra correctly, it is necessary to subtract a ‘dark’ spectrum from all subsequent transmission spectra, channel by channel, to correct for non-zero detector voltages. Next a non-NO background spectrum is acquired. The background can change with time due to deposits on the optics and changes in the light source. These changes are similar to adding a neutral density filter and can be compensated for by choosing some channel intensities below the wave length of interest, called ‘low-end background’ and some channel intensities above the wavelength of interest, called ‘high-end background’, and mathematically calculating the expected (virtual) background at the channels of interest in between the low-end and high-end backgrounds. This provides background and NO component spectra with each scan.

Calculating the virtual background is a two-step process. First, a linear equation is calculated between the low-end background and the high-end background. Then for each channel in the area of interest, a ratio is calculated for the background sample between the measured light intensity for the background and the intensity calculated by the linear equation mentioned above. During a sample scan, the low-end background and the high-end background are measured, and a linear line is calculated for the channels between them. For this new straight line, these values are multiplied by the channel factors to give the virtual background values. Another source of change occurs when the sample being analyzed has a component at the low-end background channels or at the high-end background channels. The ratio of the high-end background and the low-end background transmission are compared in order to ignore whichever end has lower than expected transmitted intensity.

These and other features and advantages of the invention will be more fully understood from the following description of preferred embodiments of the invention taken together with the accompanying drawings. It is noted that the scope of the claims is defined by the recitations therein and not by the specific discussion of features and advantages set forth in the present description.

### BRIEF DESCRIPTION OF THE FIGURES

The following detailed description of the embodiments of the present invention can be best understood when read in conjunction with the following drawings, where like structure is indicated with like reference numerals and in which:

FIG. 1 is a schematic diagram of an analytical system used for NO measurement according to the present invention;

FIG. 2 is a graph of the ultraviolet absorbance spectrum for nitric oxide;

FIG. 3 is a graph of vehicle exhaust absorbance spectra showing absorbance versus wavelength;

FIG. 4 is a graph of spectral regions for NO analysis showing absorbance versus wavelength;

FIG. 5 is a graph of intensity versus wavelength showing the background intensity spectrum for NO-free air;

FIG. 6 is a graph of intensity versus wavelength showing the intensity spectrum for a sample containing nitric oxide;

FIG. 7 is a block diagram of the signal processing performed on data received from a UV detector according to the present invention;

FIG. 8 is a graph of intensity versus wavelength showing the intensity spectrum for a sample containing nitric oxide with virtual baseline correction according to the present invention;

FIG. 9 is a graph of nitric oxide concentration versus absorbance showing a ultraviolet nitric oxide calibration curve;

FIG. 10 is a graph of a real-time data comparison of ultraviolet nitric oxide measurements taking in accordance with the present invention with dynamometer data; and

FIG. 11 is a graph of integrated nitric oxide mass emission correlation between measurements taken according to the present invention and FTP Bag measurements.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiment(s) of the present invention.

### DETAILED DESCRIPTION OF THE EMBODIMENTS OF THE INVENTION

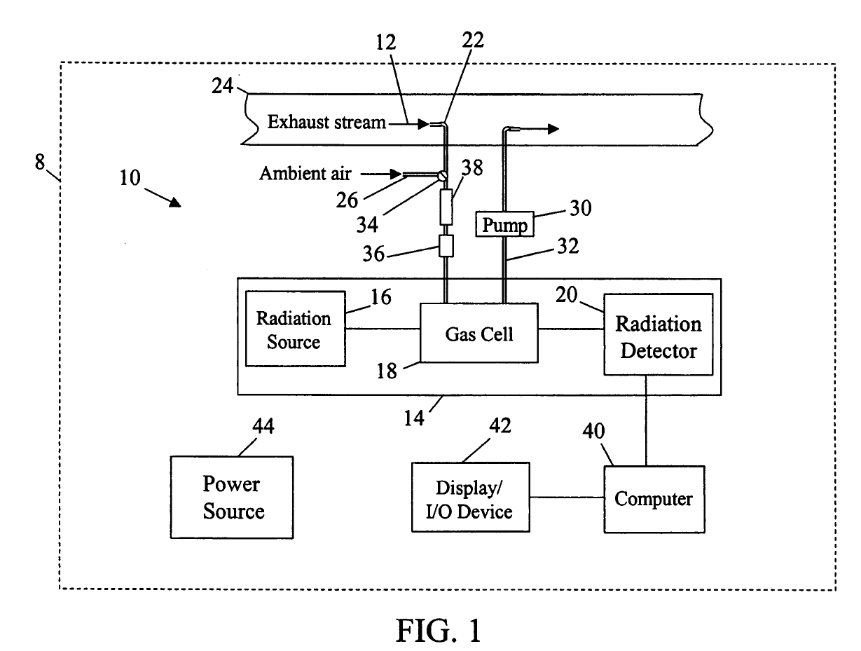

Referring to FIG. 1, on board a vehicle 8, a portable emissions measurement system 10 which provides a real-time method for the measurement of nitric oxide (NO) in undiluted vehicle exhaust stream 12 is shown. In particular, the present invention describes a unique ultraviolet (UV) spectroscopic method, which accurately accounts (95+%) for the continuously changing ultraviolet absorption background in the undiluted vehicle exhaust stream 12 during operation of the vehicle 8, thereby allowing NO to be selectively and accurately measured.

The emission measurement system 10 includes an UV radiation analyzer 14 comprising an UV radiation source 16, such as for example, a deuterium UV light source. The UV radiation source 16 is coupled to a gas transmission cell 18 via optical fiber to provide a continuous spectrum of UV light in a single optical path. The DT-1000 deuterium tungsten halogen light source (˜200-1100 nm) available from Ocean Optics Inc., Dunedin, Fla., is one such suitable radiation source 16, and the 10 cm gas cell available from Harrick Scientific Corporation, Ossining, NY, is one such suitable gas transmission cell 18. The UV radiation analyzer 14 further comprises a radiation detector 20 sensitive in the UV spectrum, such as a charge coupled device, or linear photodiode array. One suitable radiation detector is a Model S2000 Spectrometer also available from Ocean Optics Inc., which accepts light energy from the gas transmission cell 18 through an optical fiber connection.

The emission measurement system 10 also includes a first intake 22, which is coupled to an exhaust system 24 of the vehicle 8 to collect an emission gas sample from the undiluted vehicle exhaust stream 12. A second intake 26 is coupled to a portion of the vehicle separate from the vehicle exhaust system 24 to collect ambient air, which is past through a NO remover 38, for a blank gas sample, which is used in a virtual baseline calculation that is explained in a later section. The UV radiation analyzer 14 is coupled to the first and second intakes 22, 26, and provides a first electrical signal corresponding to chemical content of the blank gas sample, and a second electrical signal corresponding to chemical content of the vehicle exhaust gas sample. The first and second electrical signals from the UV radiation analyzer 14 represents the ultraviolet transmission spectra of the blank and exhaust gas samples, respectively, in a region spanning the wavelength of one of the spectroscopic features for NO.

In one embodiment, both intakes 22, 26 are coupled to an inlet 28 of the gas transmission cell 18. A pump 30 pumps on an outlet 32 of the gas transmission cell to draw a gas sample from either the first intake 22 or second intake 26. In one embodiment, an electronically controlled valve 34 is used for fluid switching to select which intake 22 or 26 is pumped on by the pump 30, thereby selecting which gas sample is drawn into the emission measurement system 10 for analysis. An electronically controlled heater 36 is provided to intake 22, valve 34, inlet 28, gas cell 18, and outlet 32 to provide a desired gas sample temperature to prevent water condensation.

The emission measurement system 10 further includes a computer 40 having a central processing unit, memory, mass storage device, an input device, and an output device, and which is used for signal processing. The emission measurement system 10 may include an optional display device 42 connected to the computer 40, such that data corresponding to the vehicle emissions and the ambient air may be displayed. Additionally, the computer 40 is used for automatic calibration of the system 10, gas sample source selection through operation of the valve 34, temperature control through the input of a thermocouple readout in the gas sample stream and operation of heater 36, and pressure control through the input of a pressure sensor 46 in the gas sample stream and operation of pump 30. The computer 40 is also used to run diagnostics and monitor for a power failure, a heater failure, a source failure, a detector failure, a pump motor failure, a leak in a gas cell, a dirty gas transmission cell, a system high temperature alarm, and electronic failure. As these applications of a computer are known processes to those skilled in the art, no further discussion is provided. It is to be appreciated that the emission measurement system 10 is powered by a power system of the vehicle 8 and/or by an included portable rechargeable power source 44, if desired. A discussion on the emission measurement method of the present invention now follows.

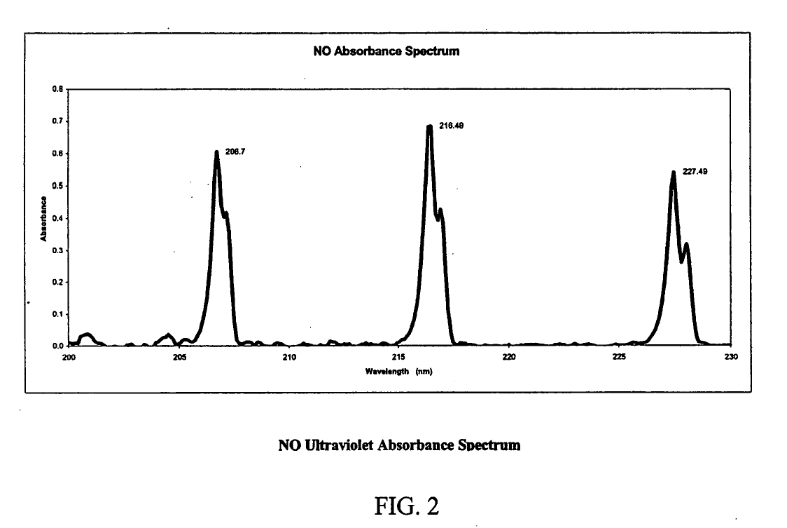

As shown in FIG. 2, there are three main spectroscopic features in the ultraviolet absorbance spectrum of NO. As illustrated, the NO spectrum has absorbance maxims at 206.70, 216.49, and 227.49 nm. The present invention uses the least intense peak (227.49 nm) for analysis due to vehicle exhaust background effects. Vehicle exhaust background effects result from innumerable species contained in the exhaust stream 12 that absorb ultraviolet light. These species vary in kind and concentration depending on engine operating and vehicle catalyst conditions (e.g., air/fuel, temperature, spark advance, fuel type, etc.), and therefore have a continuously changing contribution to a baseline of the UV absorption background.

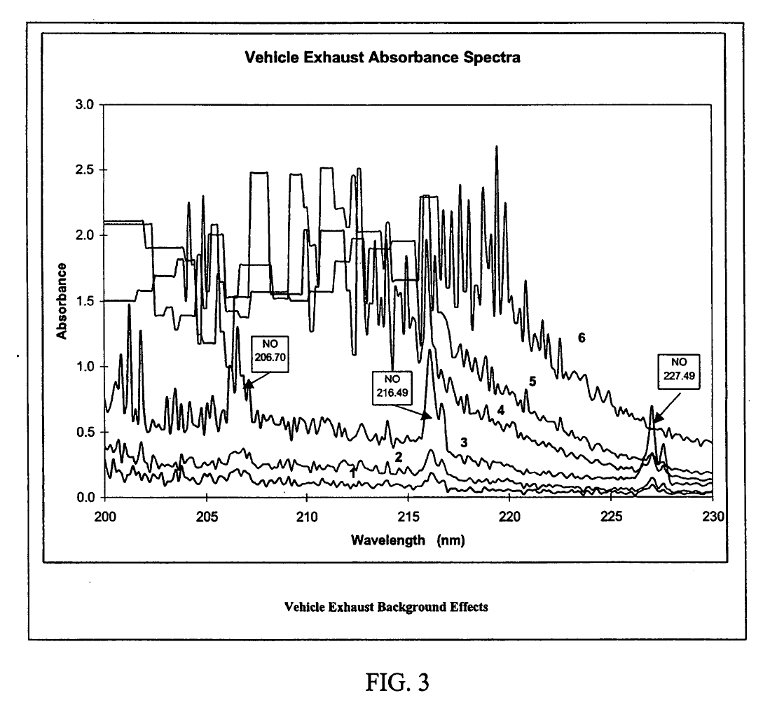

For example, six-absorbance spectra curves shown by FIG. 3 and which are labeled with symbols 1-6, illustrate such vehicle exhaust background effects. The differences in the six-absorbance spectra curves are due to varying the throttle where changes in engine revolutions (rpm), air/fuel ratios, and spark advance occur. As the engine of the vehicle changes in rpm, nitric oxide production may (curves 1-4) or may not (curves 5 and 6) occur. The absorbencies in the 227.49 nm region for curves 5 and 6 are substantial, however, they do not contain evidence of nitric oxide. Applying standard spectroscopic data analysis techniques would find high levels of nitric oxide during such engine operating modes when in fact nitric oxide is not present due to a changing baseline. This phenomenon of changing the baseline would lead to gross errors when measuring nitric oxide in the gas sample, and has been found by the inventors as the reason why nitric oxide has not been successfully measured in vehicle exhaust by UV spectroscopy. In order to use UV spectroscopy to successfully measure nitric oxide (NO), the present invention accurately accounted for this continuously changing baseline.

Referring back to FIG. 1, the method of the present invention involves measuring the intensity spectrum of the blank gas sample that is absent of NO and also measuring the intensity spectrum of the emission gas sample drawn from the undiluted exhaust stream 12, via intake 22. The blank gas sample may be, for example and not limited to, ambient air drawn from intake 26. From the UV radiation analyzer 14 as previously mentioned, signals corresponding to the blank and emission gas samples are provided to the computer 40 for signal processing, which is discussed in greater detail in a later section. The NO concentration is then calculated from the detected intensities at selected wavelengths, converting the intensity spectra to absorbance and relating the calculated absorbance to concentration established by calibration curves. It is to be appreciated that during NO analysis with the system 10, temperature and pressure of the emission gas sample are best maintained constant to improve the accuracy and reproducibility of the measurements.

In order to analyze the intensity spectra of the emission gas sample correctly, it is necessary to acquire and save the intensity spectra of the blank gas sample prior to sample gas measurements. The background intensity spectra can change with time due to deposits on the optics of the gas transmission cell 18 and/or changes in the radiation source 16. These changes are similar to adding a neutral density filter and can be compensated for by choosing some channel intensities below the wave length of interest, called ‘low-end background’ and some channel intensities above the wavelength of interest, called ‘high-end background’, and mathematically calculating the expected (virtual) background at the channels of interest.

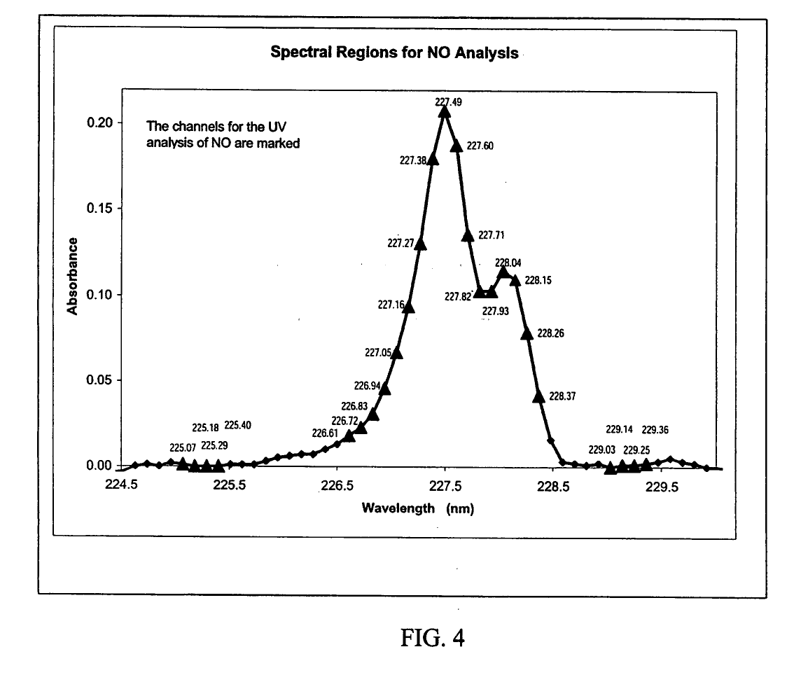

In the illustrative embodiment shown by FIG. 4, between 225.07 nm and 229.36 nm in the near ultraviolet band, forty UV spectral channels are considered by the radiation detector 20, thereby providing a pixel resolution of about 0.11 nm. In particular, twenty-five spectral channels, spanning three spectral regions, are used for NO concentration analysis. Sequentially from lowest to highest, four spectral channels in a low wavelength region 225.07-225.40 nm are averaged by the computer 40 to determine the low-end background. The next ten channels are ignored, wherein the next seventeen channels between 226.61 and 228.37 nm contain one of the NO peaks and are used to provide intensity spectra of the sample gas. The next five channels are also ignored, wherein the last four channels in a high wavelength region 229.03-229.36 nm are averaged by the microprocessor to determine the high-end background. If desired, more or less spectral channels may be used for finer or coarser NO concentration analysis.

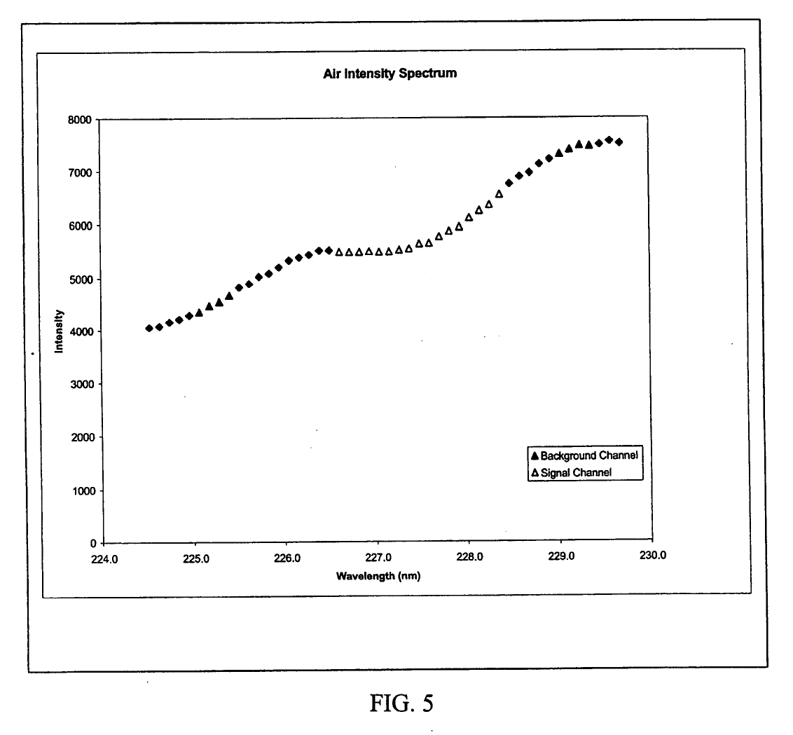

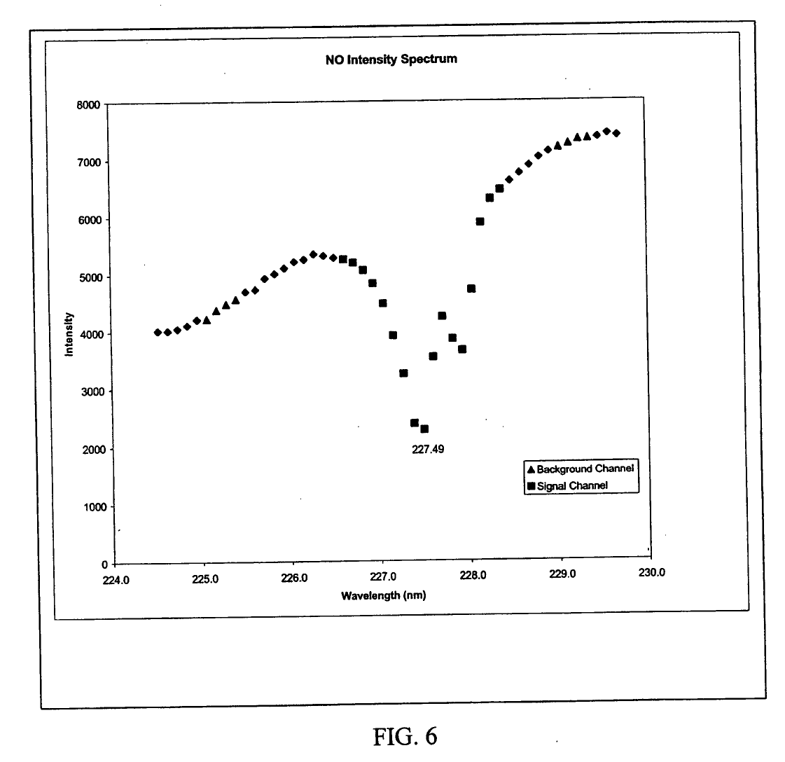

FIG. 5 shows an example of an intensity spectrum of NO-free air. This spectrum is used to establish the relative relationships between the background spectral channels (225.07-225.40 nm, 229.03-229.36 nm), and the sample spectral channels (226.61-228.37 nm). FIG. 6 shows the intensity spectrum of a gas sample containing NO. It is to be appreciated that the background spectral channels are selected on their spectral proximity to the sample spectral channels for NO analysis and their independence of NO influence (non-NO absorbing). These background spectral channels used for baseline correction must reflect the intensity changes due to non-NO species that absorb UV light. A discussion on the determination of accurate baseline intensity for each of the signal channels for successful UV measurement of NO in the exhaust stream now follows.

Virtual Background Calculation

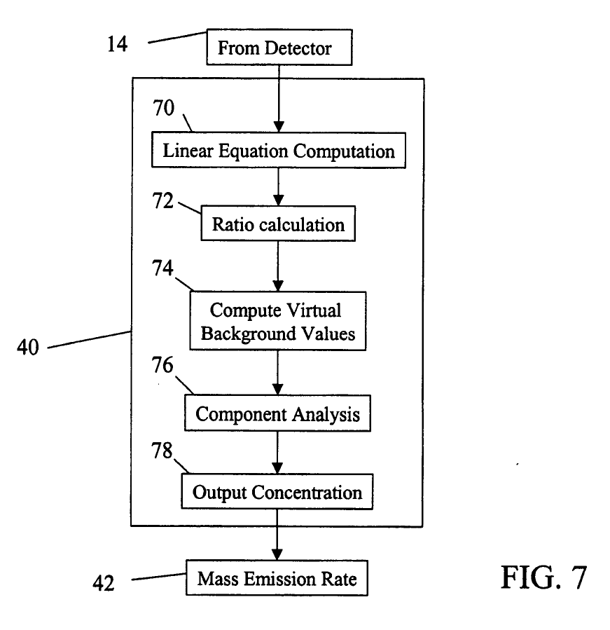

FIG. 7 illustrates in block diagram one embodiment of the emission measurement method of the present invention. After receiving from the UV radiation analyzer 14 signals corresponding to the blank and emission gas samples, as previously mentioned, the computer 40 uses an internal baseline correction algorithm (herein after referred to as the “virtual background”) to compensate for baseline changes due to non-NO UV absorbing species in the sample exhaust and variations in intensity due to physical changes of the spectrometer system. In particular, calculating the virtual background for improved accuracy is a three-step process. First, a source of change occurs when a sample being analyzed has a component that preferentially absorbs only at the low-end background or at the high-end background. The ratio of the high-end background and low-end background transmission are compared in process step 82 and the microprocessor is programmed to ignore whichever end has higher than expected absorption (i.e., a lower transmitted intensity). Second, the background spectrum is defined with respect to the low-end background and the high-end background channels. A linear equation is calculated in process step 84 between the low-end background and the high-end background. Third, for each channel in the area of interest, a previously determined non-linear correction factor is applied in process step 86 to generate the virtual background.

FIG. 7 illustrates in block diagram one embodiment as an example demonstrating the steps of the present invention conducted by the computer 40 to provide an accurate real-time analysis of concentration of a constituent component in the exhaust stream 12 of the vehicle 8. In the hereafter presented sections, the following definitions are used:

| | |
|---|---|
| i = | channel number |
| Ddark( ) = | non-zero detector intensity values |
| AB( ) = | blank gas background intensity values |
| AirHigh = | average intensity of blank gas background in |
| | high-end wavelength group |
| AL( ) = | blank gas linear background intensity values |
| AirLow = | average intensity of blank gas background in |
| | low-end wavelength group |
| Aratio = | blank gas background ratio (high-end/low-end) |
| RA( ) = | ratio of blank gas background to linear blank |
| | gas background |
| S( ) = | sample gas intensity values |
| SamHigh = | average intensity of sample gas background in |
| | high-end wavelength group |
| SamLow = | average intensity of sample gas background in |
| | low-end wavelength group |
| SB( ) = | virtual sample background values |
| SL( ) = | sample linear background values |
| Sratio = | sample background ratio (high-end/low-end). |

View FIG. 5, a span of forty channels are acquired from the radiation detector 20, twenty-five channels are used to measure a constituent component in a gas sample. As part of the initialization of the system 10, a dark intensity spectrum is determined with the light path blocked. This spectrum is stored in the software as Ddark(i)in process step 70. This spectrum is initially subtracted from all subsequent intensity spectra, correcting the data for non-zero detector voltages in process steps 72 for the blank gas intensity spectrum AB(i) and in process step 80 for the sample gas intensity spectrum S(i).

Before running an exhaust sample, a gas sample void of the constituent component (herein referred to as the “blank gas sample”) is taken and stored in order to compute for each sample channel virtual background a non-linear correction factor RA(i). A weighted relationship of the low wavelength and the high wavelength baseline channel averages is determined to define a preliminary “virtual baseline” value for each of the sample channels. This is accomplished by establishing the number of channels removed from each of the baseline groups and normalizing to the total number of channels. It is to be appreciated that although a particular number of channels are used in the following embodiments, more or less spectral channels may be used for finer or coarser concentration analysis of a constituent component in the vehicle emission. For the linear air plot, the following equation is used in process step 74:
AL(i)=(AirHigh−AirLow)*(i−4)/33+AirLow.

To more accurately compensate for any non-linearity in the actual baseline spectrum, an additional non-linear compensating factor is determined for each signal channel in process step 74. These factors are determined for each of the seventeen signal channels from the ratios of the average intensity from the actual baseline measurements and the linearly adjusted virtual baseline intensity. The final virtual baseline intensities are the result of adjustments based on both the linear and non-linear factors.

A ratio for each channel in the air spectra is calculated according to the following equation in process step 76:
RA(i)=AB(i)/AL(i).

With the detected chemical content of the blank gas sample, a ratio called “Aratio” is calculated between the high and low background values of the blank gas sample, such as air if measuring for nitric oxide content in the vehicle emission. The following equations are used in determining that ratio in process step 78:
AirLow=(AB(1)+AB(2)+AB(3)+AB(4))/4
AirHigh=(AB(37)+AB(38)+AB(39)+AB(40))/4
Aratio=AirHigh/AirLow.
In the example illustrated by FIG. 5, AirLow is the average intensity of the four channels 225.07 to 225.40 nm, and AirHigh is the average intensity of the four channels 229.03 to 229.36 nm when using the 227.49 nm spectral region for NO analysis. Having determined the non-linear correction factors RA(i) and the blank gas high/low background ratio Aratio, sample gas spectra may now be acquired for an extended period of time as long as the instrument is powered on and has light transmission.

Next, sample gas spectra S(i) are acquired in process step 80. The subsequent virtual background and component analysis is performed on each individual sample gas spectrum thus correcting for instrument and/or sample gas matrix variations. The averages for the background group ends for the vehicle exhaust sample are determined in the same manner explained above to improve the signal to noise of the individual readings. In particular, a ratio called “Sratio” is computed using the following equations in process step 82:
SamLow=(S(1)+S(2)+S(3)+S(4))/4
SamHigh=(S(37)+S(38)+S(39)+S(40))/4
Sratio=SamHigh/SamLow.

After computing the sample ratio, the microprocessor checks to see if the Sratio is reasonable. The following conditional statements are used to make that determination in process step 82:
IF Sratio>1.2*Aratio then SamLow=SamHigh/Aratio,
IF Sratio<0.8*Aratio then SamHigh=SamLow*Aratio
   The above conditional statement assumes that if either end of sample background were low it would indicate an unexpected absorption peak, which should be ignored when choosing a background. Now that the sample gas background channel intensities have been established, the process continuation follows below.

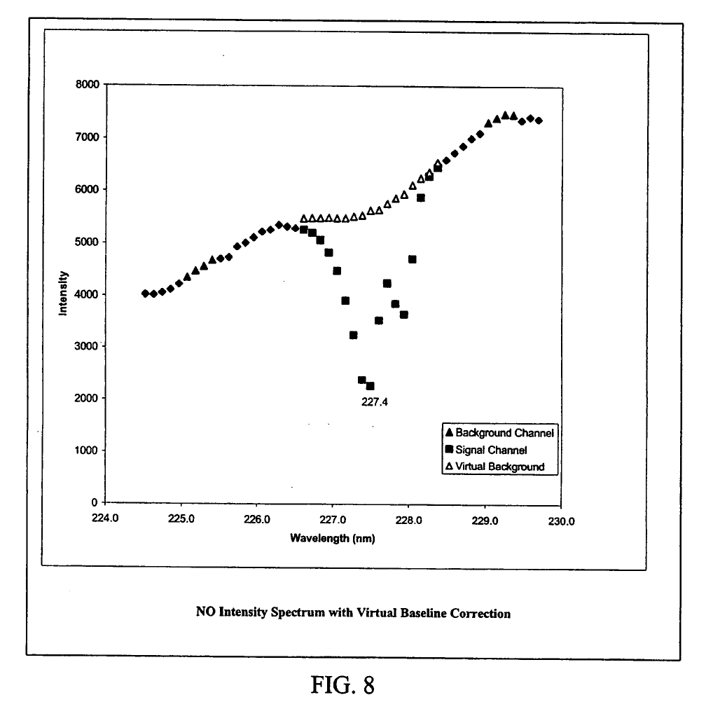

Next, the virtual background is calculated in the next two steps. First, a linear plot is calculated between the sample background ends using the following equation in process step 84:
SL(i)=(SamHigh−SamLow)*(i−4)/33+SamLow.
The final virtual background for each sample spectra scan is then calculated, wherein for each channel from channel 15 to channel 31 the following equation is used in process step 86:
SB(i)=RA(i)*SL(i).
The NO intensity spectra along with the final virtual baseline values are shown in FIG. 8.
Concentration Measurements from Intensity Spectra

In process step 88, NO absorbance values are calculated from the virtual baseline and the sample gas intensities at the selected wavelengths from the following equation:

$$A = {log}_{10} [ ( {\sum }_{n = 1}^{n = 17} \frac{SB}{S} ) / n ]$$

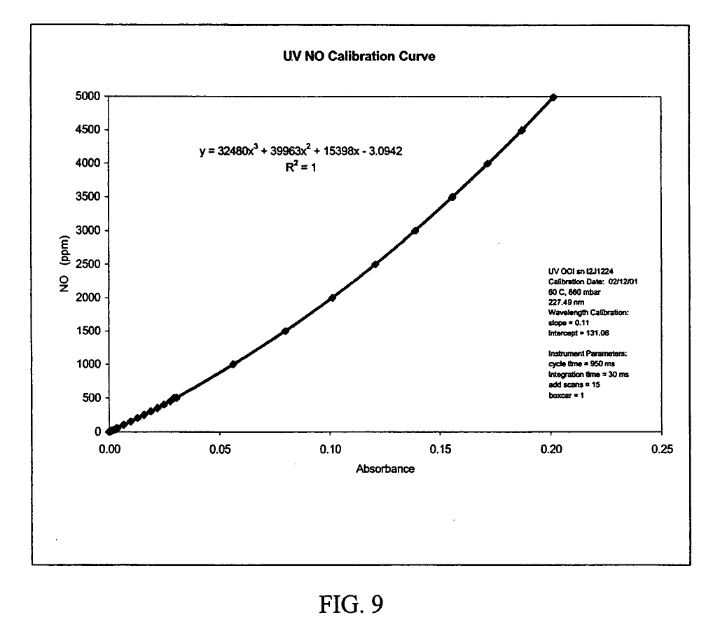

Analyzing gas standards using the procedure described above generates calibration data. A calibration curve is determined similar to FIG. 9. In the illustrated example, a temperature of 60° C., a pressure of 860 mbar, a wavelength of 227.49 nm were used. The instrument parameters included a cycle time of 950 milliseconds, an integration time of 30 milliseconds per scan, and add scan of 15 per spectrum, and a boxcar of 1 per spectrum. The spectrometer, with a wavelength calibration of a slope of 0.11 and an intercept of 131.06, produced an equation of 32480x³+39963x²+15398x−3.0942 with R²=1, where y is NO ppm and x is absorbance, which was used in one embodiment to analyze the vehicle exhaust. The output concentration, FIG. 7, process step 90, can be displayed in real-time, FIG. 1, 42, and, if desired, stored as a file, FIG. 7, process step 92, on a computer, FIG. 1, 40.

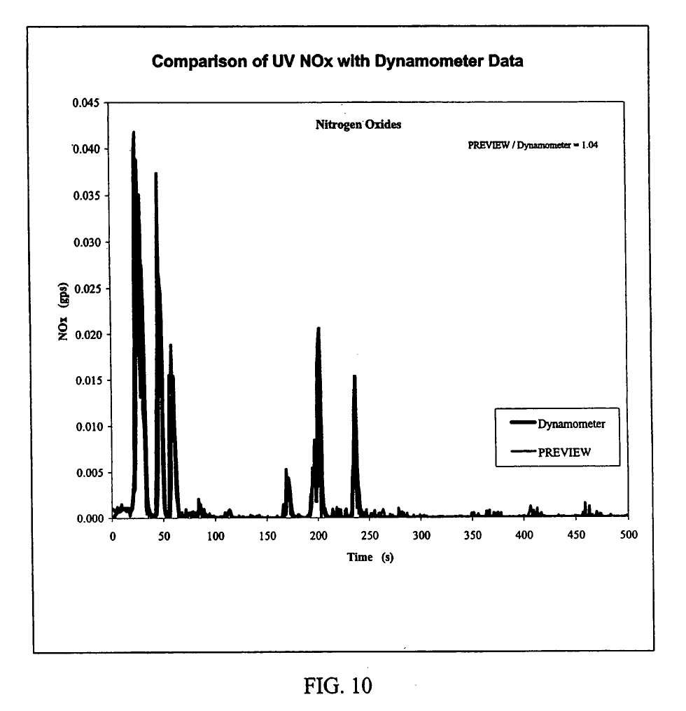

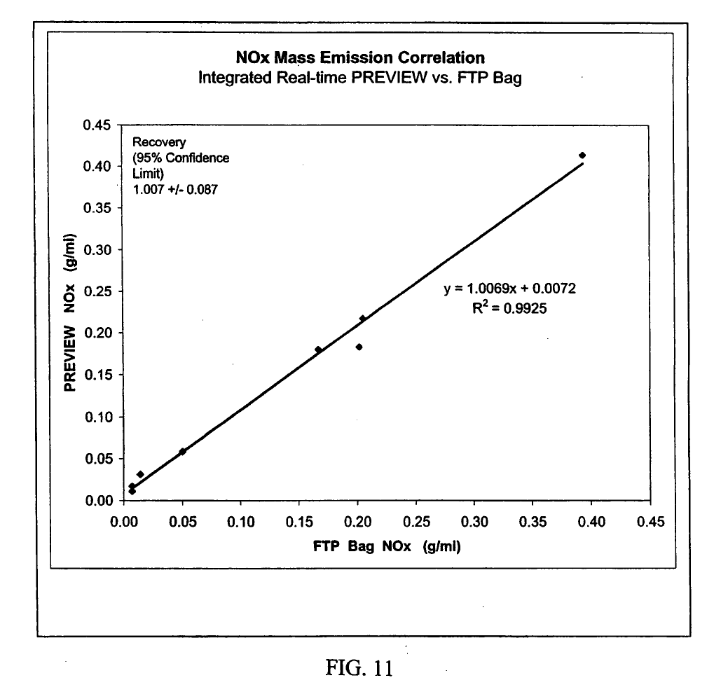

To validate the above described system and method, NO results using the present invention, when coupled with vehicle exhaust flow to generate mass, were compared with conventional dynamometer measurements of exhaust NO. Such comparisons are shown in FIG. 10, which demonstrates the excellent agreement obtained in the real-time data. Also a quantitative comparison is shown in FIG. 11, where the integrated real-time data is compared with data obtained from conventional dynamometer analysis of bag samples collected during Urban Dynamometer Driving Schedule and Highway Fuel Economy tests. FIG. 11 shows that on average the agreement between the method of present invention and conventional dynamometer analysis is within 0.7%.

While the invention has been described by reference to certain preferred embodiments, it should be understood that numerous changes could be made within the spirit and scope of the inventive concepts described. For example, while a mobile system has been shown, the present emissions measuring system could also be used in an emission laboratory as a stationary instrument. As known in the art, an emissions laboratory may be mobile and/or portable wherein the laboratory including a simple dynamometer can be transported to different locations by truck. The present emissions measuring system would have distinct advantages over such emissions laboratories in terms of size. Accordingly, it is intended that the invention not be limited to the disclosed embodiments, but that it have the full scope permitted by the language of the following claims.

1. A portable emissions measurement system transportable with a vehicle having an emissions source with a dramatic and quickly changing background environment, said system comprising:
a first intake separate from said emission source to collect a first gas sample void of a constituent component present in said vehicle exhaust gases;
a second intake coupled to said emission source to collect a second gas sample of vehicle emission gases therefrom;
an analyzer disposed in said vehicle and fluidly coupled to said first intake and said second intake, said analyzer providing a first electrical signal corresponding to chemical content of said first gas sample, and a second electrical signal corresponding to chemical content of said second gas sample; and
a computer coupled to said analyzer, said computer being adapted to process said first and second electrical signals, calculate a virtual baseline correction using said first electrical signal, and provide data corresponding to said constituent component in said second gas sample using said virtual baseline correction.

2. The portable emissions measurement system defined in claim 1, further comprising a heater and pressure regulator for providing the first and second gas samples at a constant temperature and pressure prior to being analyzed by said analyzer.

3. The portable emissions measurement system defined in claim 1, further comprising a NO remover fluidly coupled between said first intake and said analyzer.

4. The portable emissions measurement system defined in claim 1, further comprising a vacuum pump coupled to analyzer and adapted to draw the first and second gas samples therethrough.

5. The portable emissions measurement system defined in claim 1, wherein said analyzer comprises a UV radiation source, a gas cell, and a UV gas analysis spectrometer.

6. The portable emissions measurement system defined in claim 1, further comprising a display device wherein the data corresponding to the second gas sample may be displayed, said display device connected to the computer.

7. The portable emissions measurement system defined in claim 1 wherein the first gas sample is ambient air void of said constituent, and said constituent component is nitric oxide.

8. The portable emissions measurement system defined in claim 1 wherein said first and second electrical signals correspond to detected intensity spectra at selected wavelengths corresponding to an absorbance spectral region of said constituent component.

9. The portable emissions measurement system defined in claim 1 wherein said computer calculates the virtual baseline by calculating an equation between low-end background and high-end background channels from said second electrical signal of said constituent component, which correspond to detected spectral intensities of said first gas sample of said ambient air void of a constituent present at selective wavelengths corresponding to an absorbance spectral region of said constituent component.

10. The portable emissions measurement system defined in claim 9 wherein said data is concentration of said constituent component in said vehicle emission gases.

11. An ultraviolet spectroscopic method for measuring a constituent component in vehicle exhaust gases having a dramatic and quickly changing background environment, comprising:
collecting a first gas sample void of the constituent component present in said vehicle exhaust gases;
collecting a second gas sample of vehicle exhaust gases from an emission system of an operating vehicle;
providing a first electrical signal corresponding to chemical content of said first gas sample using UV radiation;
providing a second electrical signal corresponding to chemical content of said second gas sample using UV radiation;
determining a virtual background (SB) from said second electrical signal; and
using said virtual background to provide data corresponding to the constituent component in said second gas sample.

12. The method of claim 11, wherein determining the virtual background (SB) comprises computing the sample background correction:
averaging a predetermined number of spectral channels in a first wavelength spectral region to determine a low-end background of said first gas sample (AirLow);
averaging a predetermined number of spectral channels in a second wavelength spectral region to determine a high-end background of said first gas sample (AirHigh);
calculating a first ratio between values of the high-end and low-end background of the first gas sample (Aratio);
averaging the predetermined number of spectral channels in the first wavelength spectral region to determine the low-end background of said second gas sample (SamLow);
averaging the predetermined number of spectral channels in the second wavelength spectral region to determine the high-end background of said second gas sample (SamHigh);
calculating a second ratio between values of the high-end and low-end background values of the second gas sample (Sratio); and
checking to see if the Sratio is reasonable.

13. The method of claim 12, wherein the Sratio is reasonable according to the statements:
IF Sratio>1.2*Aratio then SamLow=SamHigh/Aratio, or
IF Sratio<0.8*Aratio then SamHigh=SamLow*Aratio.

14. The method of claim 11, wherein determining the virtual background (SB) comprises:
calculating a linear plot of the first gas sample (AL) between the low-end and high-end backgrounds of the first gas sample (AirLow and AirHigh)
calculating the first gas sample non-linear correction factor (RA) for each channel used for constituent analysis.

15. The method of claim 14, wherein the first gas sample liner plot (AL) is determined by using the following equation:
AL(i)=(AirHigh−AirLow)*(i−4)/T+AirLow,
where i is a channel number, and T is one plus the total number of channels between the background channels.

16. The method of claim 14, wherein further comprises determining a non-linear correction ratio (RA) for each channel in spectra of the first gas sample by calculating the following equation:
RA(i)=AB(i)/AL(i),
where AB(i) is intensity value of the first gas sample, and i is a channel number.

17. The method of claim 11, wherein determining the virtual background (SB) further comprises calculating a linear plot of the second gas sample (SL) between the low-end and high-end backgrounds of the second gas sample (SamLow and SamHigh).

18. The method of claim 17, wherein the second gas sample liner plot (SL) is determined by using the following equation:
SL(i)=(SamHigh−SamLow)*(i−4)/T+SamLow,
where i is a channel number, and T is one plus the total number of channels between the background channels.

19. The method of claim 11, wherein determining the virtual background (SB) further comprises using for each constituent channel between the low-end and high end background groups the following equation:
SB(i)=RA(i)*SL(i).

20. The method of claim 11, further comprises determining concentration of the constituent component from intensities at selected wavelengths normalized using the virtual background.

21. The method of claim 11, further comprising displaying said data of said second gas sample.
